(19) United States
(12) Patent Application Publication
(10) Pub. No.: US 2022/0185526 A1
(43) Pub. Date: Jun. 16, 2022

(54) LABELLING MACHINE FOR APPLYING LABELS TO CONTAINERS USING COLD GLUE

(71) Applicant: KRONES AG, Neutraubling (DE)

(72) Inventors: Josef MAYER, Regensburg (DE); Heinrich BIELMEIER, Pilsting- Großköllnbach (DE); Bernhard UNRECHT, Neutraubling (DE); Florian HABERSETZER, Regensburg (DE)

(21) Appl. No.: 17/593,083

(22) PCT Filed: Jan. 28, 2020
(86) PCT No.: PCT/EP2020/052050

§ 371 Date: Sep. 8, 2021

(30) Foreign Application Priority Data
Mar. 8, 2019 (DE) 10 2019 203 217.6

(51) Int. Cl. B65C 9/22; B01F 27/80; B01F 35/21; B01F 35/92

(52) U.S. Cl. CPC B65C 9/22; B01F 27/80; B01F 2035/99; B01F 35/92; B01F 35/2115

(57) ABSTRACT

The disclosure relates to a labelling machine for applying labels onto containers using cold glue, comprising a glue supply device. The glue supply device is configured to produce the cold glue from several components, in particular at least one liquid and one solid component, so that the cold glue required for applying the labels can be produced by processing the components, in particular mixing them together.

### TECHNICAL FIELD

The disclosure relates to a labelling machine for applying labels onto containers, for example, bottles or cans, using cold glue, comprising a glue supply device.

### BACKGROUND AND SUMMARY

In current labeling machines for labeling containers, the supply of cold glue required for labeling is effected discontinuously, for example, by filling in cold glue that is obtained from the glue manufacturer and filled into storage and/or transport containers.

Such a glue supply has various drawbacks.

The cold glue typically used consists of 50 to 80% water, which in principle can also be obtained as a raw material in the work area of the labeling machine and is therefore unnecessarily transported from the glue manufacturer to processing. This gives rise to significant unnecessary transport costs and environmental concerns. The finished cold glue also has a limited shelf life, for example, about 6 months from production. If the cold glue is then not consumed, then it needs to be disposed of, which is disadvantageous both in terms of price and ecology. In addition, a considerable amount of packaging waste arises in the form of storage and transport containers. For example, due to the short shelf life of the cold glue, especially after the storage and transport containers have been opened, the containers cannot be too large, which contributes to the amount of packaging waste and the frequency of deliveries. The shelf life can be improved in principle by adding preservatives, but this is also associated with costs and ecological concerns, so that it is preferable to keep the quantity of preservatives used low.

It is therefore an object of the disclosure to provide an ecologically more compatible and cheaper way of supplying cold glue.

The object is satisfied in that the glue supply device in a labeling machine of the type mentioned above is configured to produce the cold glue from several components, for example, at least one liquid and one solid component, so that the cold glue required for applying the labels can be produced by processing the components and mixing them together.

One advantage of such a labeling machine is that the transport volume for the solids or concentrates required for a certain quantity of cold glue is significantly less than for this amount of finished cold glue. Water, which makes up a large proportion of the cold glue, can then be supplied to the labeling machine from the water supply that is usually available on the company premises. This saves transport and storage costs.

In addition, since the shelf life of the solids or concentrates is significantly better than that of finished cold glue, preservatives do not necessarily have to be added or only a smaller quantity thereof and larger packs (in relation to the effective amount of cold glue) can be used without significantly increasing the risk of glue discard. This also means that there is less packaging waste.

The device claimed is therefore advantageous both for cost reasons as well as from an ecological point of view.

Cold glue can therefore be freshly produced at any time on site, i.e. on the company premises in the area of the machines where the labeling operation takes place, and used and consumed promptly, possibly even immediately upon production. Cold glue produced does not need to be transported or stored for a long time.

Cold glue is there glue that can be used as intended, namely can be applied onto labels, when it has a temperature between 15° C. and 50° C., or 20° C. and 40° C., or 20° C. and 35° C., or 24° C. and 32° C., for example room temperature. In certain embodiments, cold glue can have such a viscosity at the temperatures mentioned that it can be sprayed onto labels, for which purpose, for example, print heads can be used.

Cold glue is typically made from solid (in its initial form), such as pulverulent and liquid components. The liquid components can comprise water, concentrates, and/or aqueous solutions.

The glue supply device can comprise a mixing container, a stirring element for stirring the components in the mixing container, and at least one component container for storing one of the components which is configured and arranged in such a way that the component can be supplied from the component container to the mixing container, such as in an automated manner.

If the glue supply device is configured in this manner, it is possible, at the latest from the point in time when the components are filled into the respective component container, to carry out all production steps on site using the glue supply device. Each of the components can then be supplied directly from the component container to the mixing container and all components can be processed there to form cold glue. A stirring element with which the components are stirred can then be used for this purpose.

During operation, the component containers can be arranged above the mixing container. This enables the components to be supplied into the mixing container solely by gravity.

In some embodiments, the supply of the component to the mixing container can be controlled by a shut-off and/or metering element, for example, a valve. For example, the supply can be interrupted once the intended amount of component has been supplied to the mixing container. Such a shut-off and/or metering element can also be controlled by a control device, for example, the one described below, so that the supply can then be controlled in an automated manner.

In addition to component containers, a water connection that is in fluidic connection with the mixing container can also be provided. A shut-off and/or metering element, optionally that can be actuated by a control device or the control device, can be provided for the water connection as well.

The glue supply device can comprise a weighing device, where the weighing device is configured and arranged in such a way that it detects the mass of the components disposed in the mixing container. The weighing device can be connected to the control device and the control device can be configured such that the respective shut-off and/or metering elements are controlled taking into account the measurement values of the weighing device. In other words, the glue supply device can be configured such that a mass-related component supply can be carried out in an automated manner using the weighing device. The weighing device can comprise, for example, weighing cells, and the mixing container can be standing on the weighing cells during operation.

The mixing container can be configured to be temperature-controlled, such as heatable and/or coolable, and/or the glue supply device can comprise a temperature control element which is configured and arranged for temperature control, such as heating and/or cooling, of the mixing container.

If the mixing container itself can be heated, it can be heated by induction, for example, in that currents are induced in the mixing container. A temperature-controllable mixing container can be configured in the alternative or in addition in the form of a heat exchanger and can be heated or cooled with a fluid. For example, it can be configured with a double wall, where heating and/or cooling liquid can be delivered to the interior of the double wall. In the alternative or in addition, the wall of the mixing container can comprise a Peltier element. In the alternative or in addition, a heating cartridge can be integrated into the mixing container.

The temperature control element can be configured to heat and/or cool the container and thereby also material in the container, for example, by heating the container from the outside. The temperature control element can comprise, for example, a heating mat, a heating coil, and/or a cooling coil and/or a Peltier element that heats and/or cools the mixing container from the outside. A heating and/or cooling coil, for example, can surround at least part of the mixing container. In some embodiments, the temperature control element can be arranged in contact with the container. In the alternative or in addition, the temperature of the container can be controlled indirectly by changing the ambient temperature of the container.

It is also conceivable to control the temperature of the material in the mixing container directly, for example, by operating a temperature control element, such as a heating coil or cooling coil, immersed into the material, for example, into the solution.

For some cold glues, heating is advantageous in order to combine the components or to make the cold glue more homogeneous. Controlling the temperature, such as cooling down, can be advantageous if the cold glue produced is to be actively made to assume a temperature at which it is used for labeling. In an embodiment, if a heating step is executed during production, the cold glue can subsequently be cooled. The mixing container or the temperature control element can accordingly be configured in such a way that the temperatures required for this can be adjusted.

The labeling machine can comprise a control device which is configured to control the glue supply device, such as the stirring element and/or the temperature control element.

For example, with a stirring element driven by a drive, the control device can control the drive in such a way that the motion, for example the rotation, of the stirring element is started or stopped, also such that the stirring element moves, for example, rotates, at a speed specified by the control element. The stirring device can then be operated in an automated manner as required for the respective production step, for example, in dependence of the component(s) currently being processed. For this purpose, the control device can resort to predetermined control parameters that were previously stored. Measurement values from sensors arranged on or in the mixing container can also be taken into account in the control process.

In a similar manner, the control device can also control the temperature control element in such a way that it heats and/or cools at a predetermined output. The temperature control element can then be operated in an automated manner as required for the respective production step, for example, in dependence of the component(s) currently being processed. For this purpose, the control device can resort to predetermined control parameters that were previously stored and optionally use measurement vales.

As mentioned briefly above, the control device can also be configured to control shut-off and/or metering elements with which the supply of components can be controlled.

If the shut-off and/or metering elements, the stirring element, and the temperature control element are operated in a manner controlled by the control device, then the entire cold glue production can take place fully automated once the components have been initially filled into the component containers. For this purpose, the components can be supplied to the mixing container at a predetermined quantity and sequence by way of the shut-off and/or metering elements and can be stirred there and optionally have their temperature controlled.

The control device therefore enables the semi-automated to automated production of the cold glue. This automated production saves costs and ensures good reproducibility. The probability of errors can additionally be reduced compared to a less automated production, such as in the case of more complex production steps.

The glue supply device can comprise a glue application device and the mixing container described above can be in direct (fluidic) communication with the glue application device via a fluidic communication, also sometimes referred to hereafter as fluidic connection.

The glue application device is a device that applies the cold glue onto the labels. This can comprise, for example, a print head with which the cold glue is sprayed onto labels. However, other glue application devices are also conceivable.

A fluidic connection can comprise, for example, pipes and/or hoses. A direct fluidic connection presently means that no buffer tanks or other storage containers are provided between the mixing container and the glue application device. The advantage of such a direct connection is that overall little space is required and cleaning is very simple and inexpensive.

In the alternative, the glue supply device can comprise a glue application device and a buffer tank and the mixing container can be in fluidic connection with the glue application device via the buffer tank. The buffer tank can be connected to the glue application device via a first fluidic connection and the mixing container can be connected to the buffer tank via a second fluidic connection.

A buffer tank is a container in which the cold glue can be stored on the way from the mixing container to the glue application device. In some embodiments, the buffer tank can optionally be temperature-controlled, in particular in such a way that the cold glue can be made to assume a processing temperature and/or kept thereat, which can take place in an automated manner.

The advantage of such a buffer tank is that new cold glue can already be produced while a batch of cold glue is being used in that cold glue is removed from the buffer tank. In an embodiment, the newly produced cold glue can also have a composition that differs from that in the buffer tank. In this way, a substantially continuous glue production and labeling operation can be carried out, even when changing the cold glue recipe used.

The fluidic connection between the mixing container and the glue application device and/or the first fluidic connection and/or the second fluidic connection can each be shut off by way of a shut-off and/or metering element. The shut-off and/or metering elements can each optionally be controllable by a/the control device.

The shut-off and/or metering elements can each comprise, for example, throttle or metering valves. The supply of cold glue can be controlled by way of such shut-off and/or metering elements in an automated manner by using the control device. It can be set, for example, in the variant with the buffer tank, whether the supply device is operated in a filling mode for filling the buffer tank or in a removal mode for removing cold glue from the buffer tank in that the supply to and the removal from the buffer tank is specified by way of the shut-off and/or metering elements. A hybrid mode in which cold glue is simultaneously supplied and removed from the buffer tank is also possible using suitable shut-off and/or metering elements, such that the buffer tank is filled despite the removal of cold glue in that a removal rate which is lower than the supply rate is set by way of the shut-off and/or metering elements.

The disclosure also provides a method for operating a labeling machine, such as a labeling machine as illustrated above, for applying labels onto containers using cold glue. The method comprises producing the cold glue from several components, such as at least one liquid and one solid component, using a glue supply device of the labeling machine by processing the components, for example, by mixing them together. Features and advantages already mentioned above in the context of the device presently apply analogously and are not specifically mentioned.

In some embodiments, the method can comprise introducing, for example, in an automated manner, at least one of the components from a component container into a mixing container and stirring the components in the mixing container.

As already explained above, the supply can be controlled by way of shut-off and/or metering elements, for example, valves. The shut-off and/or metering elements can be operated manually or in a manner controlled by a control device. The stirring can take place manually or by way of a stirring element, for example, the one described above, which can be driven by a drive. The stirring can be controlled by way of the control device, for example, in that a rotational speed at which the stirring element rotates is controlled.

The method can also comprise automated, temperature control, such as heating and/or cooling, of the mixing container. As described above, a temperature control element or a heatable and/or coolable mixing container can be used for this purpose.

The method can comprise supplying the cold glue from the mixing container to a glue application device via a direct fluidic connection or supplying the cold glue into a buffer tank and simultaneously or subsequently removing the cold glue from the buffer tank during the labeling operation.

In this regard, reference is made to the explanations above. With regard to the variant in which the cold glue is supplied to the buffer tank, the method can comprise that cold glue is removed simultaneously from the buffer tank and supplied to the glue application device and cold glue is produced in the mixing container. This means that a glue production operation and a glue application operation can take place at the same time. In addition, cold glue can be supplied from the mixing tank to the buffer tank and cold glue can be removed simultaneously from the buffer tank. Thus, a glue application operation and filling of the buffer tank can take place at the same time, provided that the glue is removed at a lower rate than the glue supply.

In an embodiment, the production of the cold glue can comprise that at least one solution of pulverulent components is produced in the mixing container or supplied thereto, at least one further liquid component may be subsequently added to the at least one solution in the mixing container, the solution and the further component are stirred, and thermal treatment is carried out during or after the stirring in which the mixing container is heated to a temperature of 40° C. to 80° C., or 45° C. to 75° C., or 50° C. to 70° C.

The components can be processed in the mixing device in such a way that they are homogenized, and thermal treatment is then carried out in which the mixing container is heated to a temperature of 40° C. to 80° C., or 45° C. to 75° C., or 50° C. to 70° C.

In all of the cases mentioned above, the cold glue can be supplied to a/the glue application device or a/the buffer tank immediately after thermal treatment or after a swelling phase of a predetermined duration and/or after a cooling step.

For example, the cooling step can comprise cooling down to a temperature of about 15 to 50° C., or 20° C. to 40° C., or 20° C. to 35° C., or 24° C. to 32° C. The swelling time can be, for example, between 5 and 10 minutes, or between 4 and 15 minutes, or between 3 and 30 minutes.

The above steps can each be carried out, for example, using the elements described in the context of the labeling machine.

### BRIEF DESCRIPTION OF THE FIGURES

Further features and advantages shall be explained below using the exemplary figures, where:

FIG. 1 shows a schematic representation, not to scale, of a labeling machine according to a first embodiment; and

FIG. 2 shows a schematic representation, not to scale, of a labeling machine according to a second embodiment.

### DETAILED DESCRIPTION

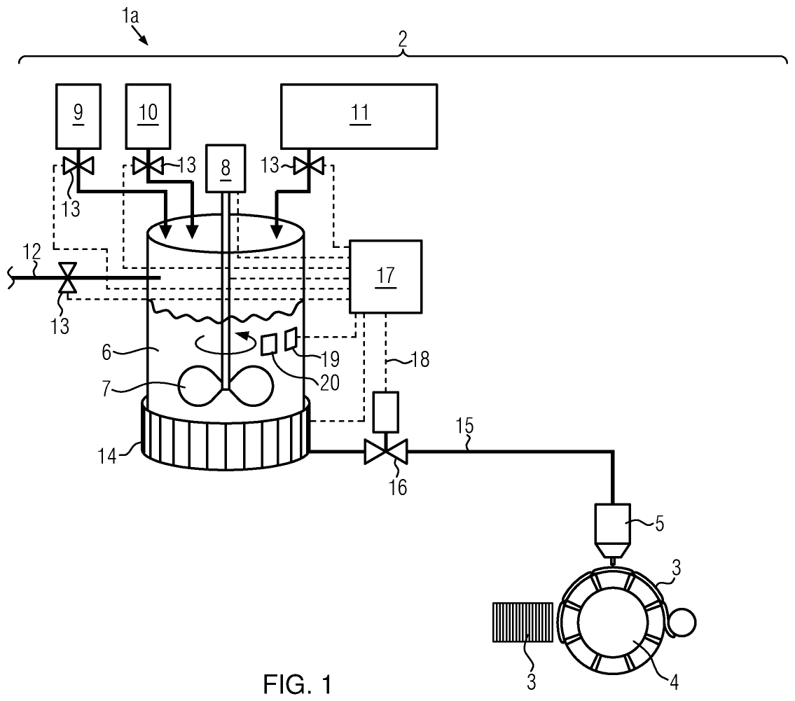

FIG. 1 shows a labeling machine 1a according to a first embodiment. The labeling machine comprises a glue supply device 2 for supplying glue during the glue application operation in which cold glue is applied onto labels 3. The glue supply device therefore serves to provide the cold glue required for labeling. The labeling machine also comprises a transport device 4, for example, comprising a rotatable drum which is configured to hold and transport the labels.

The glue supply device comprises a glue application device 5, for example, comprising a print head, for glue application onto labels 3, meaning for applying cold glue onto the labels. Transport device 4 is configured such that the labels are transported through the working region of the glue application device during the glue application operation. The working region of the glue application device is the region in which cold glue is applied to the labels.

The glue supply device is configured to produce cold glue from several components, such as at least one liquid and one solid component. For this purpose, the glue supply device can comprise a mixing container 6 and a stirring element 7 for stirring the components in the mixing container. The stirring element can be connected to a drive 8, as presently shown. The drive can be configured, for example, to drive the stirring element to rotate.

The glue supply device can furthermore comprise at least one component container 9, 10, 11 for storing one of the components each. They can each be configured and arranged in such a way that a component can be supplied from the component container to the mixing container, such as in an automated manner. The component containers in FIG. 1 are arranged, for example, above the mixing container so that the components can enter into the mixing container solely by gravity. In the alternative or in addition, however, it is also conceivable to use pumps or other transport elements by use of which the components are supplied to the mixing container.

Two component containers 9 and 10 for solid components and one component container 11 for liquid components are shown in FIG. 1 by way of example. As an alternative or in addition to such a component container for liquid components, a water connection 12 can also be provided. A shut-off and/or metering element 13 can optionally be provided between the component containers and the mixing container as well as at the water connection, as shown in FIG. 1.

As shown in FIG. 1, the glue supply device can also comprise a temperature control element 14 for temperature control, such as for heating and/or cooling, of the mixing container, for example, in the form of heating and/or cooling coils.

The labeling machine further comprises a fluidic connection, fluid connection 15, between the mixing container and the glue application device. A direct fluid connection between the mixing container and the glue application device is shown in FIG. 1, in which no other elements, such as buffer tanks are provided. This fluidic connection can optionally be able to be shut off. For this purpose, the labeling machine can comprise a shut-off and/or metering element 16, for example, in the form of a valve. The glue supply to the glue application device can therefore be controlled by way of the valve.

It is understood that the mixing container can be closable towards fluid connection 15 so that the individual components do not escape into fluid connection 15 during the glue production.

The labeling machine can also comprise a control device 17. This control device can be connected via data connections 18 to one or more of shut-off and/or metering elements 13 and/or shut-off and/or metering element 16 and/or stirring element 7 and/or drive 8 and/or temperature control element 14 and be configured to control these elements.

The labeling machine can optionally comprise one or more sensors 19, 20, for example temperature or viscosity sensors or sensors of a weighing device, for example, to monitor the production of the cold glue. For example, the temperature of the mixing container and/or the material in the mixing container and/or the viscosity of the material in the mixing container and/or the mass of the components disposed in the mixing container can be detected by way of such sensors. The values measured can be stored and/or visualized on a display.

In the above-mentioned embodiment, the control device can be configured such that it controls all manufacturing steps, i.e. the component supply by way of shut-off and/or metering elements 13, the stirring speed of the stirring element, and the temperature by way of the temperature control element. For this purpose, the control device can access and execute a corresponding control program. Measurement values recorded by way of sensors, for example, sensors 19 and 20 described above, can optionally also be taken into account, for example, the temperature of the mixing container and/or of the material in the mixing container and/or the viscosity of the material in the mixing container and/or the mass of the material in the mixing container, where the latter can be used for automated mass-related component supply.

The labels with the glue applied by way of the glue application device can be applied to the containers by pressing them thereonto, thus labeling the containers. This can be done by way of known devices which presently need not be explained in detail.

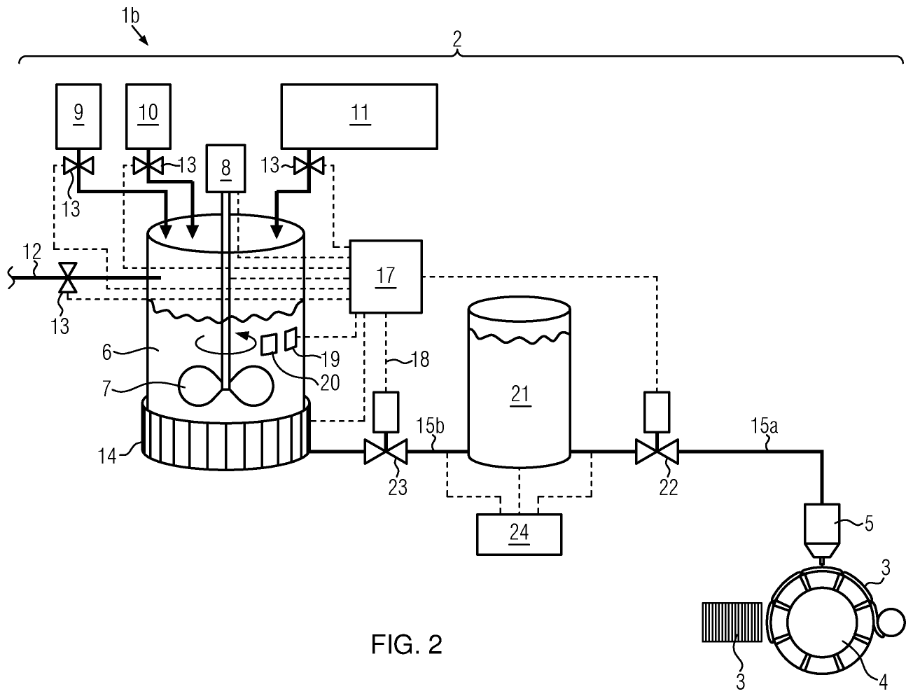

Labeling machine 1b shown in FIG. 2 according to a second embodiment can likewise comprise the elements explained above in the context of FIG. 1. The same reference signs as in FIG. 1 are used here. However, elements can also be exchanged or omitted.

In addition, the labeling machine there comprises a buffer tank 21. Instead of valve 16, two shut-off and/or metering elements in the form of valves 22 and 23 are shown there. First valve 22 is configured and arranged to shut off a first fluid connection 15a between the buffer tank and the glue application device. The glue supply to the glue application device can be controlled by way of the first valve. It therefore fulfills a function similar to that of valve 16 in the first embodiment.

Second valve 23 is configured and arranged to shut off a second fluid connection 15b between the mixing container and the buffer tank. The glue supply to the buffer tank can be controlled by way of the second valve. In certain embodiments, it can be controlled with these two valves whether and at what rate cold glue is supplied to or removed from the buffer tank, in particular whether this takes place simultaneously, possibly at different rates, or successively. The arrangement of the second embodiment can be used in particular with two open valves 22 and 23 and the same supply and withdrawal quantity, which enables an operation similar to the first embodiment.

It is understood that the mixing container here as well can be closed towards the fluid connection so that the individual components remain in the mixing container during glue production and do not escape into the fluid connections.

With the arrangement shown in the second embodiment, cold glue can therefore be produced and used almost continuously, which avoids downtimes for repeat production of cold glue.

In addition, the quantity of cold glue required can be freshly produced for each batch of labels and supplied to the buffer tank and consumed there. The composition of the cold glue is therefore the same for the entire batch. In addition, while one type of cold glue is being used in the buffer tank, another type or a fresh batch of cold glue can be produced in the mixing container, so that a quick changeover can then take place with a short downtime.

In this context, it is advantageous to use a so-called cleaning-in-place (CIP) process which enables the fluid connections, the mixing container, and/or the buffer tank to be cleaned quickly between the cold glue batches. A CIP cleaning device 24 which is basically known and presently only indicated schematically can be used for this purpose. It is understood that such CIP processes or CIP cleaning devices can also be used in the context of the first embodiment.

Two methods for operating a labeling machine for applying labels onto containers using cold glue, such as one of the labeling machines described above, shall be described hereafter.

An example of a method according to the disclosure for operating a labeling machine comprises producing the cold glue from several components. The cold glue is there produced using a glue supply device of the labeling machine. The labeling machine can be, for example, one of the labeling machines described above or a different labeling machine according to the disclosure.

The cold glue is produced from several components, such as at least one liquid and one solid component, by processing the components, for example, by mixing them together.

The method comprises supplying at least one of the components from a component container into a mixing container. For this purpose, for example, a shut-off or metering element between the component container and the mixing container can be actuated. The components can optionally be supplied in an automated manner. For example, automated actuation of the shut-off or metering element can be controlled by way of a control device so that a predetermined quantity of the component is supplied to the mixing container.

In addition, water can also be supplied as one of the components from the water network to the mixing container, likewise by actuating a shut-off or metering element which can optionally also be actuated in an automated manner by way of the control device.

The components can be supplied simultaneously or one after the other, which shall be explained in detail below.

The components are stirred in the mixing container. This can be done manually or by machine, for example, by way of a stirring device. In the case of automated stirring, the stirring device can be driven to rotate by a drive, for example, the drive described above. Different values for the rotational speed can be adjustable, can be controlled by the control device.

It is conceivable that only a subgroup of a plurality of components is initially supplied to the mixing container and stirred and further components are subsequently added. For example, all pulverulent components can first be supplied and stirred and then liquid components can be supplied. Alternatively, only liquid components can initially be supplied and stirred and pulverulent components can be supplied successively or together and stirred. It is also conceivable that first a solution made of at least one liquid component and at least one pulverulent component is produced by supplying and stirring, and further components are supplied and stirred thereafter.

Furthermore, the production of the cold glue can also comprise at least one temperature control step. This temperature control step can take place, for example, by controlling the temperature of the mixing container. For this purpose, the mixing container itself can be coolable and/or heatable, the latter, for example, by way of induction heating. In the alternative or in addition, the mixing container can be temperature-controlled by way of a temperature control element, for example, the temperature control element described above.

The method can comprise one or more such temperature control steps, which can also differ from one another in terms of the temperature. A temperature control step can be executed, for example, during or after all the components have been stirred. However, it is also conceivable that initially only a subgroup of the components is stirred and a temperature control step is executed concurrently or afterwards, after which further components are then added.

Temperature control can comprise heating and/or cooling. The temperature control steps can each also be executed in an automated manner and controlled, for example, by way of a/the control device.

Once the cold glue has been produced, it can be supplied from the mixing container via a direct fluidic connection to a glue application device, for example, the glue application device described above, and applied onto labels. For example, a labeling machine as described in embodiment 1 can be used for this purpose, such as the direct fluid connection 15 shown there.

Such a method for the production of cold glue takes place discontinuously. While cold glue is being produced, the labeling machine cannot be supplied with cold glue from the mixing container and no cold glue can be produced in the container during the labeling operation, i.e. when cold glue is being removed from the mixing container. However, such a method makes it possible to dispense with a buffer tank and several fluidic connections, so that less control and cleaning effort is required. Should it be desired to carry out a longer continuous labeling operation, then this can be implemented, for example, by adding additional mixing containers and stirring elements in a modular manner.

Alternatively, the cold glue can be supplied first to a buffer tank after production instead of directly to the glue application device. The fluidic connection, for example, above-described second fluid connection 15b, between the mixing container and the buffer tank can then be interrupted and the production of cold glue in the mixing container can commence again. After being supplied from the mixing container, the cold glue can be removed from the buffer tank and supplied to the glue application device via a second fluidic connection, for example, first fluid connection 15a described above. It is also conceivable that a portion of the cold glue supplied to the buffer tank is removed and supplied to the glue application device while the buffer tank is being filled with cold glue. A labeling machine as described in embodiment 2 can be used for this purpose, for example, fluid connections 15a and 15b shown there and the buffer tank.

Cold glue can thus be produced substantially continuously and the labeling operation can also be substantially continuous. While the buffer container is being emptied during operation, cold glue can already be produced again in the mixing container. In addition, a changeover between different glue recipes can take place almost without interruption, as already explained above.

The supply of cold glue into the buffer tank and/or to the glue application device can likewise be controllable by the control device, for example, in that the latter controls shut-off and/or metering elements in the fluidic connections.

With the method according to the disclosure, for example, a cold glue can be produced that contains 10% casein, 0.6% sodium hydroxide solution, 10% urea, 0.4% sheet silicate (bentonite), 0.1% froth prevention agent (nonionic surfactant), 0.1% preservative (chloromethylisothiazolinone) and is added water to 100% (data in % by weight). Such cold glue has a viscosity such that it can be sprayed. Other compositions, such as other proportions, are also conceivable. In certain embodiments, a lower proportion of preservatives can optionally be provided or preservatives can be dispensed with entirely.

The cold glue produced like above and supplied to the glue application device can be pressurized to a predetermined working pressure, for example, with a suitable pump, supplied to a print head, and, for example, controlled by way of valves controllable by a control device, ejected from spray nozzles arranged in a grid.

In this case, the glue application is effected without contact by way of a glue jet. The labels to be applied the glue can be transported continuously through the work region of a print head and have the glue applied in the process. However, the cold glue can also be applied to labels by the glue application device using other methods. The labels with the glue applied can then be applied to containers by way of known methods.

Examples of preparation options that can be used in the production processes explained above shall be described hereafter.

In the first option, several aqueous solutions are produced, in each of which one of several pulverulent components is dissolved. For example, an aqueous solution each with casein, with urea, and with phyllosilicate can be produced, supplied to the mixing container, and stirred there with further liquid components. Alternatively, an aqueous solution in which all pulverulent components are contained can also be produced in the mixing container. The remaining components can then be added to the mixing container and mixed with the solution.

Alternatively, there is also the possibility of supplying all components in their delivered form together or separately successively, regardless of whether they are solid or liquid, to the mixing container and mixing and homogenizing them there. Stirring can there take place by way of the stirring element and the homogenization can be supported by way of the temperature control element.

During and/or after the mixing and possibly the homogenization of the components, the material can be thermally treated in the mixing container. For this purpose, the mixing container can be temperature-controlled, for example, as described above. The material can there be heated to a temperature of 40° C. to 80° C., or 45° C. to 75° C., or 50° C. to 70° C.

After thermal treatment, the cold glue can be supplied to the glue application device or the buffer tank immediately or after a swelling phase of a predetermined duration, for example, between 5 and 10 minutes, or between 4 and 15 minutes, or between 3 and 30 minutes.

Subsequent to the heating and possibly the swelling, a cooling step can also take place, for example, to a temperature of about 20° C. to 50° C., or 25° C. to 45° C., or 30° C. to 40° C.

It is understood that the features mentioned in the embodiments described above are not restricted to these specific combinations and are also possible in any other combination.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A labelling machine for applying labels onto containers using cold glue, said labelling machine comprising a glue supply device,
wherein said glue supply device is configured to produce said cold glue from several components so that said cold glue required for applying said labels can be produced by processing said several components.

2. The labelling machine according to claim 1, where said glue supply device comprises a mixing container, a stirring element for stirring said several components in said mixing container, and at least one component container for storing one of said several components which is configured and arranged in such a way that said several components can be supplied from said at least one component container to said mixing container.

3. The labelling machine according to claim 2, where said mixing container is configured to be temperature-controlled and/or said glue supply device comprises a temperature control element which is configured and arranged for temperature control of said mixing container.

4. The labelling machine according to one of the claim 1, further comprising a control device which is configured to control said glue supply device.

5. The labelling machine according to claim 2, where said glue supply device comprises a glue application device and said mixing container is connected directly to said glue application device via a fluidic connection.

6. The labelling machine according to claim 2, where said glue supply device comprises a glue application device and a buffer tank and said mixing container is in fluidic connection with said glue application device via said buffer tank.

7. The labelling machine according to claim 6, where said buffer tank is connected to said glue application device via a first fluidic connection and said mixing container is connected to said buffer tank via a second fluidic connection.

8. The labelling machine according to claim 7, where said fluidic connection and/or said first fluidic connection and/or said second fluidic connection can each be shut off by way of a shut-off and/or metering element.

9. A method for operating a labelling machine for applying labels onto containers using cold glue, the method comprising:
producing said cold glue from several components using a glue supply device of said labelling machine by processing said several components.

10. The method according to claim 9 comprising introducing at least one of said several components from a component container into a mixing container and stirring said several components in said mixing container.

11. The method according to claim 10 comprising temperature control of said mixing container.

12. The method according to claim 10, further comprising supplying said cold glue from said mixing container to a glue application device via a direct fluidic connection or supplying said cold glue into a buffer tank.

13. The method according to claim 10, where the production of said cold glue comprises that
at least one solution of pulverulent components be produced in said mixing container or supplied thereto,
at least one further component be subsequently added to said at least one solution in said mixing container,
said solution and said at least one further component be stirred,
and thermal treatment be carried out during or after the stirring in which said mixing container is heated to a temperature of 40° C. to 80° C., or 45° C. to 75° C., or 50° C. to 70° C.

14. The method according to claim 10, where said several components can be processed in said mixing device in such a way that they are homogenized, and thermal treatment is subsequently carried out in which said mixing container is heated to a temperature of 40° C. to 80° C., or 45° C. to 75° C., or 50° C. to 70° C.

15. The method according to claim 13, where said cold glue after thermal treatment is supplied to a/said glue application device or a/said buffer tank immediately or after a swelling phase of a predetermined duration and/or after a cooling step.

16. The labelling machine according to claim 1, wherein the several components comprise at least one liquid and one solid component, so that the cold glue can be produced by mixing the several components together.

17. The labelling machine according to claim 2, wherein the several components can be supplied from the at least one component container to the mixing container in an automated manner.

18. The labelling machine according to claim 3, wherein the mixing container is configured to be temperature-controlled as heatable and/or coolable, and/or the glue supply device with the temperature control element is configured and arranged for heating and/or cooling of the mixing container.

19. The labelling machine according to claim 4, wherein the control device is configured to control the stirring element and/or said temperature control element.

20. The labelling machine according to claim 8, wherein the shut-off and/or metering element can be controlled by the control device.
